(19) United States
(12) Patent Application Publication
(10) Pub. No.: US 2026/0172520 A1
(43) Pub. Date: Jun. 18, 2026

(54) EMBEDDING NEARBY USER PRESENCE WITHIN CAPTURED IMAGES

(71) Applicant: Motorola Mobility LLC, Chicago, IL (US)

(72) Inventors: Blake Abel, Chicago, IL (US); Hua Zhang, Hinsdale, IL (US); Tom R. Schirtzinger, Fontana, WI (US); Tiago Viscardi Bagni, Chicago, IL (US); Michael E. Russell, Lake Zurich, IL (US)

(73) Assignee: Motorola Mobility LLC, Chicago, IL (US)

(21) Appl. No.: 18/980,479

(22) Filed: Dec. 13, 2024

(51) Int. Cl. H04N 1/21; G01S 5/02; G06F 16/51; H04N 23/63

(52) U.S. Cl. CPC H04N 1/2112; G01S 5/0249; G06F 16/51; H04N 23/63; H04N 2201/3225

(57) ABSTRACT

Techniques for embedding nearby user presence within captured images are described and implementable to save users from manually identifying people, and without automated facial recognition technology. In implementations, a mobile device includes a radio to scan and exchange radio messages, and a camera configured to frame an environment within a camera field of view. The mobile device reviews the radio messages scanned within the environment for a second mobile device to derive a radio based position estimate of the second mobile device, obtains optical angle and depth estimates from a camera viewfinder to identify an image region associated with the radio based position estimate of the second mobile device, and generates metadata of an image captured by the camera to tag the image with a user identifier based on the radio messages to indicate presence of a user of the second mobile device in the image region.

### BACKGROUND

Manually tagging individuals in photos for social media or personal albums can be tedious and time-consuming, especially for events like large weddings and office gatherings where some people may be unrecognizable or unfamiliar to a user (e.g., a photographer). Accurately identifying everyone and ensuring that no one is overlooked during the upload or sharing process presents a significant challenge. While facial recognition and computer vision models exist for automating aspects of photo tagging, these conventional models rely on extensive sample sets of personal facial data and high-performance processing systems to work effectively. These existing solutions are often too complex or cost-prohibitive and raise privacy concerns, e.g., from processing facial recognition data to identify other people.

### BRIEF DESCRIPTION OF THE DRAWINGS

Aspects of embedding nearby user presence within captured images are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of embedding nearby user presence within captured images can be implemented in accordance with one or more implementations.

FIG. 2 depicts a block diagram of an example system that can be implemented for embedding nearby user presence within captured images in accordance with one or more implementations.

FIG. 3a depicts an example graphical user interface (GUI) in accordance with one or more implementations.

FIG. 3b depicts an example GUI in accordance with one or more implementations.

FIG. 3c depicts an example GUI in accordance with one or more implementations.

FIG. 3d depicts an example GUI in accordance with one or more implementations.

FIG. 4 illustrates a flow chart depicting an example method for embedding nearby user presence within captured images in accordance with one or more implementations.

FIG. 5 illustrates a flow chart depicting an example method for embedding nearby user presence within captured images in accordance with one or more implementations.

FIG. 6 illustrates various components of an example device in which aspects of embedding nearby user presence within captured images can be implemented in accordance with one or more implementations.

### DETAILED DESCRIPTION

Techniques for embedding nearby user presence within captured images are described and are implementable to save users from manually identifying people individually, and without using complex facial recognition or computer vision technology. For instance, the described techniques enable automatic tagging of images as the images are being captured, to include user identifiers of people located nearby or contained in the frame. The user identifiers facilitate efficient and accurate sharing of the tagged images with each person in the image or each person located nearby, even if that person is not visually recognizable from analyzing pixels of the image.

In at least one implementation, a mobile device, such as a mobile phone, a tablet device, a laptop computer, a wearable device, and so forth, includes one or more radios and a camera. The camera and the radios are controlled by at least one processor to obtain range and direction measurements to other nearby devices in an environment. The processor correlates radio based measurements derived from operating the radio(s) with optical measurements taken from the camera to precisely locate nearby devices (e.g., user identifiers of the devices) present in the environment.

Imagine a user is holding the mobile device and pointing a camera lens towards the environment. A user input received by the mobile device causes the processor to launch a camera application (e.g., program, thread, service, or executable instructions). The camera application manages a user interface for controlling the camera and presenting a camera viewfinder showing a camera lens perspective of the environment. As the camera application starts up, the processor controls the radio to initiate a scan for radio messages (e.g., signals, communications, broadcasts, transmissions) within the environment. In some examples, the processor checks for existing scanned radio messages if the radio is seemingly always scanning. For example, a radio of the mobile device transmits communication request messages in the message environment, and receives communication response messages from other radio enabled devices, in reply. In at least one example, a Bluetooth™ or Bluetooth Low Energy™ (BLE) radio is controlled by the processor to implement short-range data exchanges by communicating short-range messages between devices based on the radio messages. In at least one example, the processor controls an Ultra-Wideband (UWB) radio to exchange UWB messages with other nearby devices to obtain more precise location estimates. Other types of radio technologies used by the mobile device may include Near Field Communication (NFC) radios, Radio Frequency Identifier (RFID) radios, Wi-Fi® radios, and cellular radios (such as LTE and 5G), each enabling various connectivity and range and direction finding capabilities.

Initiating the scan quickly (e.g., early on as the camera application starts) improves the accuracy and responsiveness of the camera application, e.g., to facilitate tagging action photos and images captured quickly in the moment. For example, as is made apparent below, when the camera application commands a radio scan prior to detecting a camera capture command, the camera application has more processing time and can collect more information for deriving accurate radio based measurements that coincide with when an image is captured. The additional time and information enables the camera application to control different types of radios and implement a variety of radio-based position estimation techniques to embed user identifiers within captured images, automatically.

During the scan, the camera application causes the processor of the mobile device to analyze the radio messages to detect user identifiers of other mobile devices in the environment. In this example, the radio messages include at least one radio message communicated by a second mobile device, which describes a device identifier associated with the second mobile device. The radio message may include information that describes other characteristics of the second mobile device, such as a user identifier (e.g., a unique user identifier or UUID) and whether a user of the second mobile device has opted in to allowing the mobile device to tag images using that user identifier.

Based on the radio message, the camera application uses the radio to interrogate the second mobile device and derive a radio based position estimate relative the camera field of view. For example, the mobile device includes a patch antenna operatively coupled to the radio. The camera application communicates with the radio to derive the radio based position estimate using Angle of Arrival (AoA) techniques enabled by the patch antenna. In at least one other example, the radio based position estimate is determined by the processor of the mobile device using Visual Inertial Odometry (VIO) techniques. In at least one example, radio settings or radio parameters are provided to the camera application to derive or further improve the radio based position estimate. In one or more implementations, the radio based position estimate is updated one or more times prior to detecting the capture command, which further improves accuracy of the radio based position estimate relative to the captured image.

When the user has framed the environment in the camera viewfinder, the mobile device receives a user input that causes the camera application to send a capture command to the camera. The camera captures an image of the camera field of view in response to the capture command, and sends the captured image to the camera application or provides access to the captured image from the camera application. In at least one example, camera settings or camera parameters are provided to the camera application when the image is captured. For example, a field of view size or direction is used to bound an area for scanning or detecting other mobile devices in the environment. The camera parameters prevent the camera application from analyzing radio messages received from devices located behind the camera viewfinder, for example. A depth map may be used to delineate different distances between the camera lens and different regions of the field of view. In at least one example, some of the camera settings (e.g., the depth map) are managed by the camera viewfinder, e.g., which reports pixel depths, viewing angles, compass directions, etc.

The camera application obtains optical angle and depth estimates from the camera viewfinder to identify an image region of the captured image that encompasses or is associated with the radio based position estimate of the second mobile device. For example, the camera application correlates the radio based position estimate with the camera based estimates to determine whether the second mobile device was nearby (e.g., framed by or outside the camera field of view) when the image was captured. As one example, a radio based direction derived from using the radio is mapped by the camera application to an azimuth angle on an azimuth plane of the camera field of view. A radio based range derived from using the radio is projected to an elevation angle on an elevation plane of the camera field of view (which is orthogonal to the azimuth plane). The camera application correlates the radio based range and direction to corresponding azimuth and elevation values of a group of pixels of the image, which is referred to as an image region. In some examples, the camera application correlates the radio based range and direction to a boundary image region of the captured image, which is beyond the camera field of view. If the camera application is unable to correlate the radio based range and direction of the second mobile device to a corresponding image region, then the camera application refrains from attempting to tag the image with a user identifier of the second mobile device. For example, if the azimuth angle is outside the field of and further away from the camera direction (e.g., approaches ninety degrees relative the camera direction), then a user of the second mobile device is not likely to be present in the image.

Next, the camera application generates metadata of the image captured by the camera. The metadata is generated for tagging (e.g., labeling, cataloging, classifying) the image with a user identifier based on the radio messages to indicate presence of a user of the second mobile device in the image. In one or more implementations, the metadata describes the image region where the user presence is estimated. The metadata is generated to embed the user identifier in the image such that when the image is shared, the metadata is shared with the image. In various aspects, the camera application enables removal of the metadata, or removal of specific user identifier references, through the user interface. The user has control over what information is embedded in images captured with the mobile device.

The user identifier is obtained based on the radio message in various ways. In some examples, the user identifier is embedded in a description received within the radio message. In another example, the camera application communicates with a remote service to obtain a user identifier that corresponds to a device identifier learned from the radio message. For example, each mobile device user opts in or opts out of an automatic tagging service implemented across the mobile devices. The user of the second mobile device, for instance, has an account with the automatic tagging service and consents to sharing that user's user identifier with other mobile devices. The camera application communicates a device identifier of the second mobile device to the automatic tagging service and receives the user identifier of the second mobile device in reply. In at least one other example, the camera application includes or accesses a contact directory of user identifiers maintained on the mobile device. The camera application searches the contact directory for the device identifier of the second mobile device to obtain the user identifier of the second mobile device based on the radio message.

With the metadata embedded in the image, the mobile device outputs the tagged image. For example, the tagged image is stored in an image and video storage of the mobile device. As another example, the tagged image is sent to a gallery application executing on the mobile device, which maintained the tagged image within the image and video storage (e.g., within a gallery).

Once the tagged image is output from the camera application, the user identifiers enable various other applications and services that process the metadata. For example, the tagged image is sent to a photo album service that catalogs the tagged image based on the user identifier tagged by the metadata to group the tagged image with other images tagged with overlapping user identifiers. As another example, the tagged image is output to a data sharing service that automatically sends the image to one or more accounts linked to user identifiers tagged by the metadata. For example, the user of the mobile device is presented an image sharing user interface and through user input, manually selects, or automatically selects all, the user identifiers described by the metadata to send the image. As another example, the tagged image is sent to a publishing service that automatically includes an indication of the user identifier overlaid at the image region in a media post of the image. A social media service, for instance, publishes a media post of the image and includes a caption describing the user identifiers tagged in the image, optionally, designating each image region where the user identifiers are positioned in the frame.

Accordingly, techniques described herein enable the automatic embedding of nearby user identifiers within captured images. By enabling the automatic embedding of nearby user identifiers within captured images, the described techniques reduce a user burden of manually identifying individuals in photos without relying on complex facial recognition technologies and complex computer vision techniques. The described techniques are operable to identify users present in images, including users whose faces are unrecognizable, obscured, or masked. Privacy concerns are reduced by not relying on sensitive facial data and by preventing tagging of users that opt out of the service. Tagging images as the images are being captured to include user identifiers of people located nearby or contained in the frame facilitates efficient and accurate image cataloging and sharing.

While features and concepts of embedding nearby user presence within captured images can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

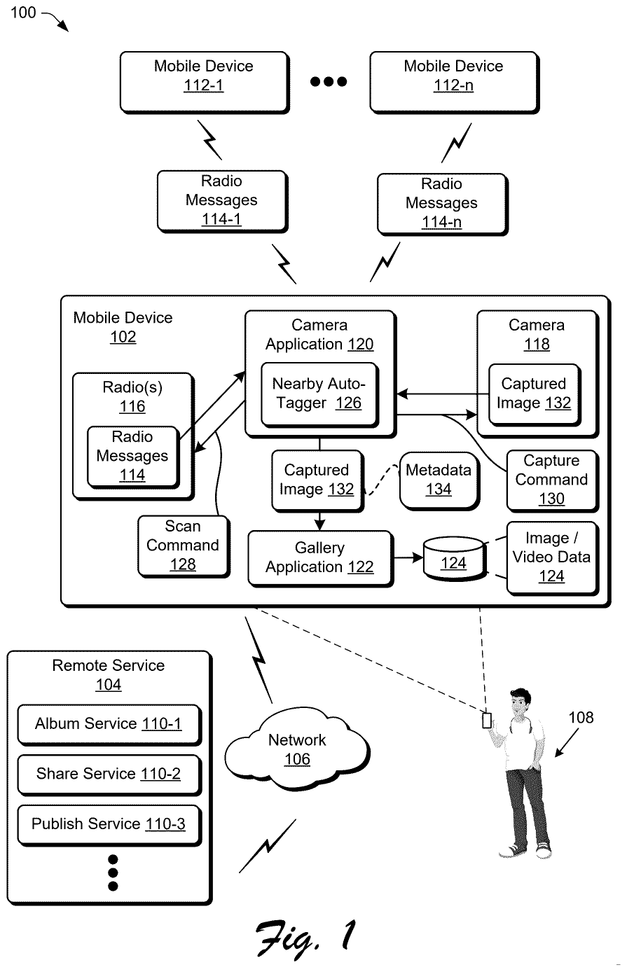

FIG. 1 illustrates an example environment 100 in which aspects of embedding nearby user presence within captured images can be implemented in accordance with one or more implementations. The environment 100 includes a mobile device 102 and a remote service 104, which are communicatively coupled through a network 106. Various entities of the environment 100 can be connected and communicate via the network 106. The network 106, for example, can represent a combination of wired and wireless networks via which the mobile device 102 and the remote service 104 can participate in various types of communication, such as wired and/or wireless data communication. The network 106 facilitates data exchanges between services, applications, and threads executing locally on the mobile device 102 and remotely as part of the remote service 104.

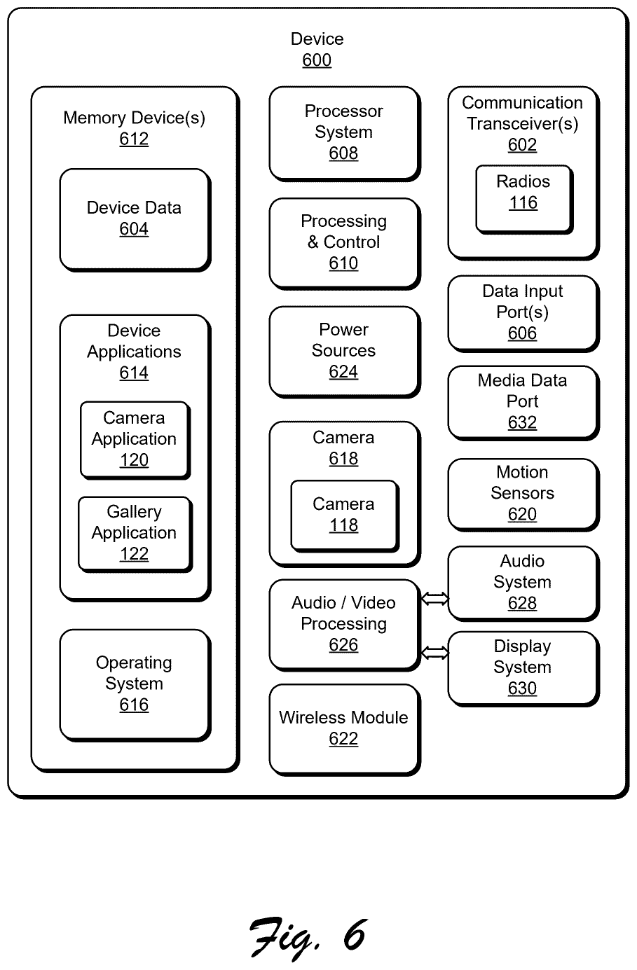

The mobile device 102 represents any device that can be used and perform operations in response to user inputs from a user 108. For example, the user inputs are detectable by the mobile device 102 as tactile, audible, and visual inputs. The mobile device 102 can represent any type of an electronic and/or computing device implemented with various components, such as a processor system and memory, as well as any number and combination of different components as further described with reference to the example device 600 shown in FIG. 6.

In implementations, the remote service 104 represents one or more network-based services that are accessible by the mobile device 102 to perform different remote functions or remote operations implemented by the remote service 104. The remote service 104 can be implemented by various entities, such as a social media entity, a digital media entity, such as a streaming music, video, or game distributer, an enterprise entity, a government entity, a data storage and/or management entity, and/or combinations thereof. The user 108, for instance, can interact with the mobile device 102 to access the remote service 104 to perform different image based transactions. For example, the mobile device 102 communicates through the network 106 with an album service 110-1. Images captured by the mobile device 102 are uploaded to a cloud-based photo catalog managed by the album service 110-1. As another example, the user 108 provides inputs that cause the mobile device 102 to communicate through the network 106 with a share service 110-2. Images captured by the mobile device 102 are distributed through the network 106 with other devices and accounts linked to the share service 110-2. The mobile device 102 may communicate through the network 106 with a publish service 110-3. Images captured by the mobile device 102 are embedded in social media posts published through one or multiple social media services that are interoperable with the publish service 110-3.

The environment 100 supports radio communication between the mobile device 102 and a plurality of second mobile devices 112 located nearby. A second mobile device 112-1, for example, exchanges radio messages 114-1 in the environment 100 with the mobile device 102, and radio messages 114-n are exchanged in the environment 100 between the mobile device 102 and a second mobile device 112-n. The second mobile devices 112 represent a group of n radio enabled communication devices, where n is any integer, that are in communication range of one or more radios 116 the mobile device 102. For example, each of the radios 116 is operable to exchange the radio messages 114 with the plurality of second mobile devices 112 within the environment 100.

The radios 116 are configured to transmit and receive the radio messages 114 using various radio technology to transmit and receive radio signals that include data (e.g., messages) communicated among devices collocated in the environment 100. For example, the radios 116 may include a Bluetooth™ or BLE radio and the radio messages 114 may be Bluetooth™ or BLE based short-range data exchanges between the mobile device 102 and the second mobile devices 112. In at least one example, the radios 116 include a UWB radio and the radio messages 114 are UWB based data exchanges between the mobile device 102 and the second mobile devices 112. Other types of radio technologies that may be used in various implementations of the radios 116 include RFID radios, NFC radios, Wi-Fi® radios, and cellular radios.

Each of the radios 116 enables radio frequency based position (e.g., range and direction) finding capabilities. For example, the radio messages 114 are exchanged to infer radio based position estimates of each of the second mobile devices 112 relative the mobile device 102. Radio based measurements are based on data (e.g., message content, device identifiers, user identifiers) inferred from the radio messages 114 and other attributes (e.g., timing characteristics, time of flight, reception characteristics, direction of arrival or angle of arrival, signal strength, channel frequency, message type, other characteristic) of the radio messages 114. The radios 116 or other component of the mobile device 102 (e.g., a processor, a signal processor) uses the radio based measurements to output the radio based position estimates computed for each of the second mobile devices 112.

The mobile device 102 is depicted having a camera 118, which is controlled by a camera application 120 executing on one or more processors of the mobile device 102. For example, the user 108 interacts with the mobile device 102 through a user interface managed by the camera application 120 to cause the camera 118 to capture images of the environment 100. The camera application 120 outputs the images captured to a gallery application executing at the mobile device 102 that stores the captured images among image and video data 124, such as an image gallery maintained in memory or local storage of the mobile device 102.

The camera application 120 and the gallery application 122, and components of each thereof, may be implemented as a module that includes independent processing, memory, and/or logic components functioning as a computing and/or electronic device integrated with the mobile device. In at least one implementation, the camera application 120 and the gallery application 122 are part of a same module, which is executed in an application execution environment of the mobile device 102 (e.g., an operating system executed by a central processing unit or CPU of the mobile device 102). The camera application 120 and the gallery application 122 may represent individual programs, threads, services, or executables. Alternatively or in addition, the camera application 120 and the gallery application 122, and components of each thereof, can be implemented as a software application or software module, such as integrated with the operating system running on the CPU, for instance, based on computer-executable instructions loaded in memory or storage of the mobile device 102. As software applications or modules, the camera application 120 and the gallery application 122, and supporting components of each may also be implemented as one or more artificial intelligence algorithms and/or machine learning algorithms. Alternatively or in addition, the camera application 120 and the gallery application 122, and related parts of each may be implemented in firmware and/or at least partially in computer hardware. For example, at least part of the camera application 120 is executable as firmware, and another part is implemented by a software executable, and another part is implemented in logic or circuitry of the mobile device 102.

The camera application 120 includes a nearby auto-tagger 126 component or feature that configures the camera application 120 to automatically tag of images being captured with user identifiers of people (e.g., associated with the second mobile devices 112) present in the images. The camera 118 and the radios 116 are controlled by the camera application 120 to configure the nearby auto-tagger 126 to obtain range and direction measurements to the second mobile devices 112, which may be framed by a camera field of view or outside the field of view of the camera 118. The range and direction measurements can include one or more of the second mobile devices 112 that are obscured in a line of sight from the camera 118. For example, the measurements are obtained for the second mobile devices 112 that are inside clothing, pockets, purses, luggage, backpacks, fanny packs, and hand bags, or behind other people associated with other devices in the environment 100.

Picture the user 108 holding the mobile device 102 to point a camera lens of the camera 118 in the environment 100 in the direction of the second mobile devices 112. The camera application 120, for instance, displays camera controls within the user face to receive user inputs for controlling the camera 118. A camera viewfinder is included in the user interface to show the user 108 a camera lens perspective of the environment 100 that helps the user 108 frame a scene while interacting with the camera controls.

The user 108 provides a user input to the mobile device 102, which causes the camera application 120 to launch. When the camera application 120 launches, the nearby auto-tagger 126 outputs a scan command 128 to the radios 116 to initiate a radio scan for the radio messages 114. Receiving the scan command 128 causes the radios 116 to initiate communications in the environment 100 by exchanging the radio messages 114 with the second mobile devices 112. In at least one implementation, the nearby auto-tagger 126 beings executing without delay, for instance, seemingly as an immediate reaction to the camera application 120 starting. By configuring the nearby auto-tagger 126 to initiate the scan quickly (e.g., as soon as the camera application 120 starts), responsiveness of the nearby auto-tagger 126 improves. The improved responsiveness improves accuracy of the nearby auto-tagger 126 when processing images quickly (e.g., the user 108 is taking repeated shots from one or more different vantage points) or when capturing action scenes (e.g., where objects or people are moving in and out of the camera field of view).

During the scan, the radio messages 114 are analyzed by the nearby auto-tagger 126 to detect the second mobile devices 112, and derive user identifiers of one or more of the second mobile devices 112 that are captured in the camera field of view (e.g., within an image region of the camera viewfinder, beyond an outer image region of the camera viewfinder). For example, the radios 116 compute radio based measurements of the second mobile device 112-1 based on the data and other attributes the radios 116 or the nearby auto-tagger 126 derive from the radio messages 114-1. The mobile device 102 can include a patch antenna operatively coupled to the radios 116, and the radio based measurements reported using the radios 116 may include an estimated angle of arrival for the radio messages 114 received through the patch antenna. In at least one other example, the radio based position estimate is determined using VIO techniques applied to multiple radio based measurements reported over time. A plurality of radio based measurements may be obtained at different moments leading up to receiving a capture command 130. The plurality of radio based measurements obtained prior to the capture command 130 are combined with features of a captured image 132 taken in response to the capture command 130 to account for rotation of the mobile device 102 and derive the radio based position estimate using VIO.

Analysis of the radio based measurements obtained using the radios 116 enables the nearby auto-tagger 126 to derive radio based position estimates of the second mobile devices 112. The radio based position estimates are projected on an azimuth and elevation plane of the camera field of view to be mapped to corresponding image regions of the captured image 132. For example, when the user 108 has framed the environment 100 in the camera viewfinder, the mobile device 102 receives a user input that causes the camera application 120 to send the capture command 130 to the camera 118. When the capture command 130 is received, the camera 118 produces the captured image 132 by recording pixel information to represent a view of the environment 100 that is consistent with the camera viewfinder.

The nearby auto-tagger 126 receives the captured image 132 from the camera 118, in addition to obtaining optical angle and depth estimates from the camera viewfinder. For example, camera settings or camera parameters are provided from the camera 118 to the nearby auto-tagger 126 when the captured image 132 is generated. A field of view size, a line of sight angle, a camera direction, or other camera information is used to define a depth map for correlating the radio based position estimates to corresponding pixel locations of image regions of the captured image 132.

Based on the optical angle and depth estimates recorded in the depth map and other camera information associated with the captured image 132, the nearby auto-tagger 126 identifies a corresponding image region that encompasses or is associated with a radio based position estimate of each of the second mobile devices 112. For example, the nearby auto-tagger 126 correlates the radio based position estimate of the second mobile device 112-1 to one of the different image regions framed by the camera field of view correlating to the captured image 132. As one example, a radio based direction derived from the radio messages 114-1 is mapped to an azimuth angle on an azimuth plane of the camera field of view, and a radio based range derived from the radio messages 114-1 is projected to an elevation angle on an elevation plane of the camera field of view (which is orthogonal to the azimuth plane). The nearby auto-tagger 126 correlates the radio based range and direction to corresponding azimuth and elevation values of an image region (e.g., a group of pixels) of the captured image 132. If the nearby auto-tagger 126 fails to correlate a radio based range and direction of the second mobile device 112-1 to a corresponding image region of the captured image 132, then the nearby auto-tagger 126 refrains from attempting to tag the captured image 132 with a user identifier of the second mobile device 112-1. For example, if the azimuth angle is beyond an angle boundary or boundary margin of the field of view, then a user of the second mobile device 112-1 is not likely to be present in the captured image 132. A boundary margin is used to capture the user of the second mobile device 112-1 when present at or just beyond an edge of the captured image 132.

Next, the nearby auto-tagger 126 generates metadata 134 of the captured image 132. The metadata 134 is created for tagging or recording user identifiers associated with the second mobile devices 112, which are localized to corresponding image regions of the captured image 132. The metadata 134 is configured to be embedded in the captured image 132 with other metadata contained in the captured image 132, such as geolocation tags, and device information about the camera 118 and the mobile device 102 used to generate the captured image 132. In at least one implementation, the metadata 134 records the image region corresponding to each unique user identifier. For example, nearby auto-tagger 126 generates the metadata 134 to associate or tag a first image region of the captured image 132 with a user identifier of the second mobile device 112-1 and to associate or tag a second image region of the captured image 132 with a user identifier of the second mobile device 112-n. Subsequent processing of the metadata 134 enables efficient image labeling, for example, modifying the captured image 132 to depict text of each user identifier overlaid at a corresponding image region.

The nearby auto-tagger 126 obtains the user identifiers in various ways. In some examples, the user identifier is embedded in a description received within the radio messages 114. In another example, the camera application 120 communicates with the remote service 104 to obtain user identifiers that correspond to device identifiers derived from the radio messages 114. For example, each user of the second mobile devices 112 either consents or opts out of allowing the nearby auto-tagger 126 or automatic taggers of other devices to indicate the user's presence images. The remote service 104 manages multiple user accounts associated with an automatic image tagging service. The nearby auto-tagger 126 sends a device identifier of the second mobile device 112-1 through the network 106 and receives the user identifier of the second mobile device 112-1 in reply. In at least one other example, the camera application 120 includes or accesses a contact directory of user identifiers maintained on the mobile device 102. The camera application 120 searches the contact directory for the device identifier of the second mobile device 112-1 to obtain the user identifier.

With the metadata 134 embedded in the captured image 132, the camera application 120 outputs the captured image 132. For example, the camera application 120 sends the captured image 132 to the gallery application 122. The gallery application 122 stores the captured image 132, including the metadata 134, among the image and video data 124 maintained locally on the mobile device 102.

Once the captured image 132, including the metadata 134, is output from the camera application 120, the user identifiers enable various other applications and services that process the metadata 134. In some examples, the mobile device 102 opens a communication channel (e.g., using the radios 116, through the network 106) with the second mobile devices 112 to send the captured image 132 and the metadata 134 directly to the other users associated with the captured image 132. In another example, the captured image 132 is sent to the album service 110-1 to catalogs the captured image 132 based on the user identifiers described in the metadata 134. The captured image 132 may be output to the share service 110-2 to automatically send the captured image 132 to one or more accounts linked to the user identifiers being tagged by the metadata 134. As another example, the captured image 132 is published (e.g., to the network 106, to the internet) using the publish service 110-3, which processes the metadata 134 to add user labels and captions to multimedia posts, e.g., press releases, social media posts.

The mobile device 102, the second mobile devices 112, and the remote service 104 can be implemented in various ways and include various functionality, examples of which care discussed below with reference to the example device 600 of FIG. 6. Having discussed an example environment in which the disclosed techniques can be performed, consider now an example system, scenarios, and additional details for implementing the disclosed techniques.

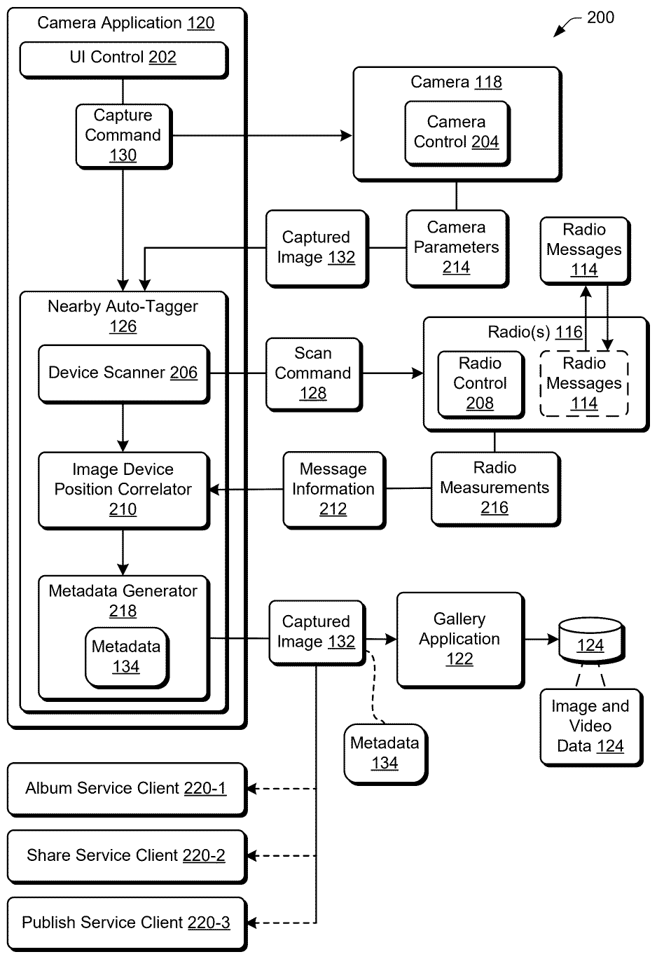

FIG. 2 depicts a block diagram of an example system 200 that can be implemented for embedding nearby user presence within captured images in accordance with one or more implementations. For example, the system 200 is described in the context of the environment 100 and being implemented on the mobile device 102 using similarly labeled components as FIG. 1.

The camera application 120 in this example includes a user interface (UI) control labeled UI control 202, which outputs the capture command 130 to the camera 118 and the nearby auto-tagger 126. The UI control 202 manages the user interface of the camera application 120 including to receive inputs from the user 108 to control the camera 118.

The camera 118 includes a camera control 204. The camera control 204 controls a shutter of the camera 118 in response to receiving the capture command 130. Camera parameters 214 are output from the camera control 204 to indicate conditions of the camera 118 when the captured image 132 is taken, such as optical angle and depth estimates associated with the different image regions of the captured image 132. The camera application 120 receives the captured image 132 and the camera parameters 214 as inputs to the nearby auto-tagger 126.

As depicted in FIG. 2, the nearby auto-tagger 126 includes a device scanner 206, an image device position correlator 210, and a metadata generator 218. The device scanner 206 outputs the scan command 128 to the radios 116 when the camera application 120 is launched. The device scanner 206 is configured to scan for the radio messages 114 before the user 108 takes a picture (e.g., before the UI control 202 outputs the capture command 130). A radio control 208 receives the scan command 128 from the device scanner 206, which causes the radios 116 to transmit and receive the radio messages 114 communicated with the second mobile devices 112. Based on the radio messages 114, the radio control 208 outputs message information 212 and radio measurements 216 to the image device position correlator 210.

As one example, the radio measurements 216 are based on the radio messages 114 that are scanned during a measurement period occurring prior to detecting the capture command 130. The radio measurements 216 may support a plurality of radio based position estimates for one of the second computing devices 112 (e.g., the second mobile device 112-1) during the measurement period. The measurement period may be set to enable sufficient collection of the radio measurements 216 to support at least three, or at least four different radio based position estimates for the second mobile device 112-1. Based on the in part on the multiple radio based position estimates derived during the measurement period, the image device position correlator 210 may implement visual-inertial odometry techniques to project the radio based position estimates onto a single image region of the captured image 132.

As another example, the radio measurements 216 are based on the radio messages 114 that are received using a patch antenna of the mobile device 102. The image device position correlator 210 may implement angle of arrival techniques to project a radio based direction estimate onto a single image region of the captured image 132. For example, the image device position correlator 210 processes the radio measurements 216 to derive a radio based position estimate using the patch antenna of the mobile device to project the radio based position estimate onto a corresponding image region of the captured image 132.

The metadata generator 218 generates the metadata 134 of the captured image 132. For example, a device identifier table or other data structure is output from the image device position correlator 210. The device identifier data structure includes a list of unique device identifiers obtained from the message information 212 extracted from the radio messages 114 received from the second mobile devices 112. Linked to each unique device identifier in the data structure is a corresponding image region from the captured image 132. The metadata generator 218 determines whether each device identifier is associated with a user identifier that is opted into the automatic tagging service. The metadata generator 218 may replace or append the device identifiers maintained in the data structure received from the image device position correlator 210 with user identifiers linked to the corresponding image regions.

With the metadata 134 embedded in the captured image 132, the camera application 120 outputs the captured image 132, including the metadata 134, to the gallery application 122 for storing the captured image 132 and the metadata 134 among the image and video data 124. In at least one example, an album service client 220-1 executed on the mobile device 102 and outputs the captured the captured image 132 and the metadata 134 to be processed by the album service 110-1. In at least one other example, a share service client 220-2 executes on the mobile device 102 and outputs the captured the captured image 132 and the metadata 134 to be processed by the share service 110-2. A publish service client 220-3 may execute on the mobile device 102, which outputs the captured the captured image 132 and the metadata 134 to be processed by the publish service 110-3.

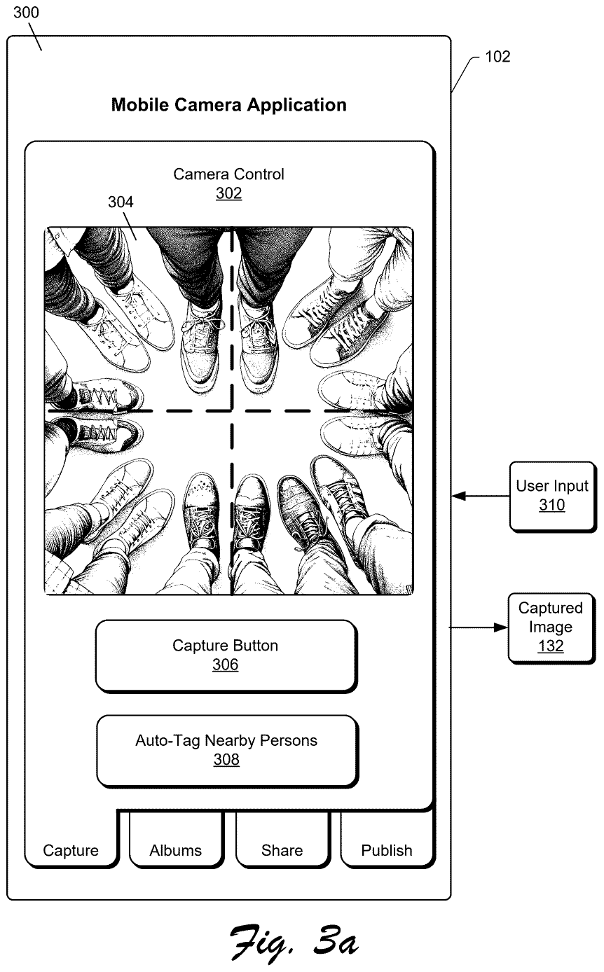

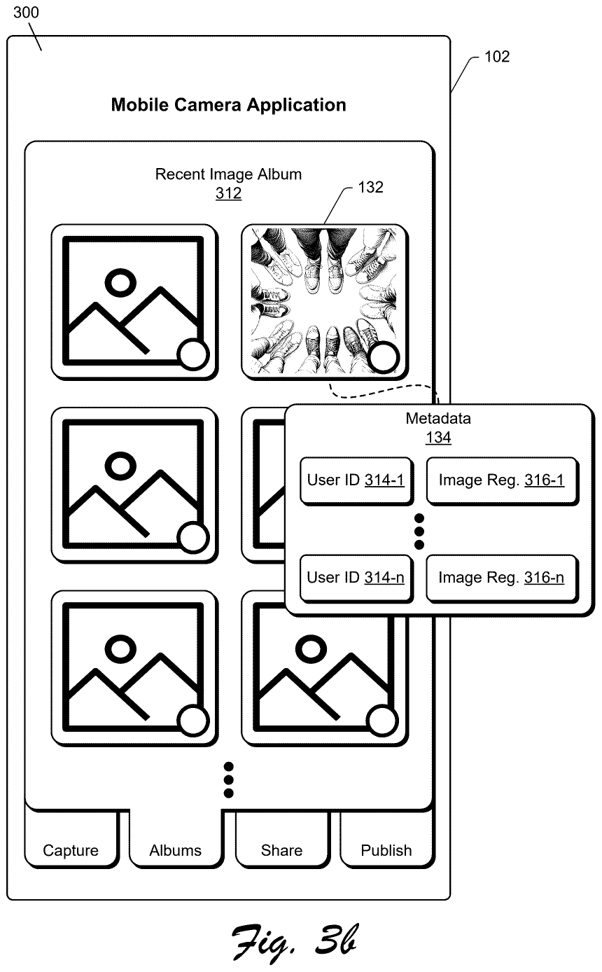

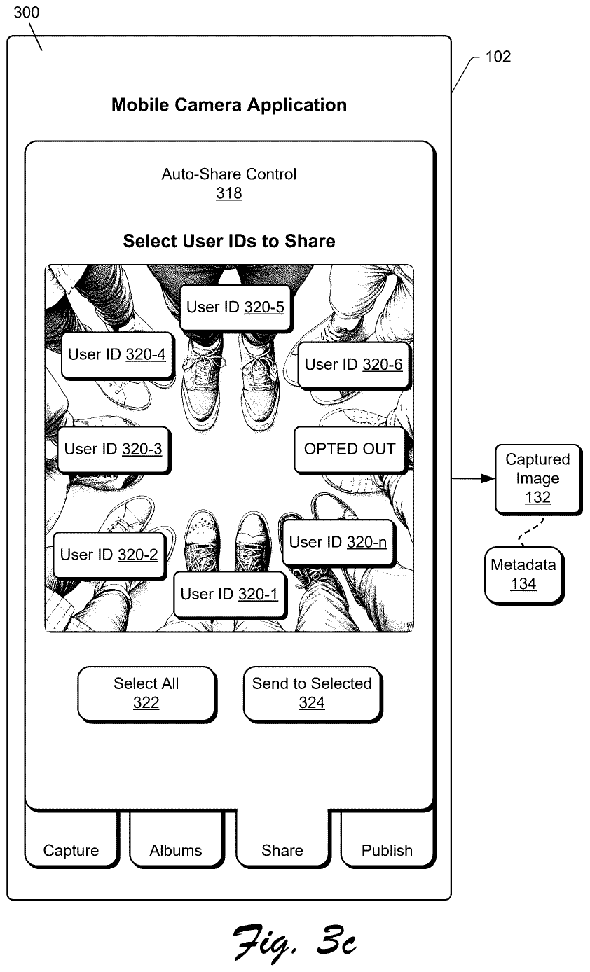

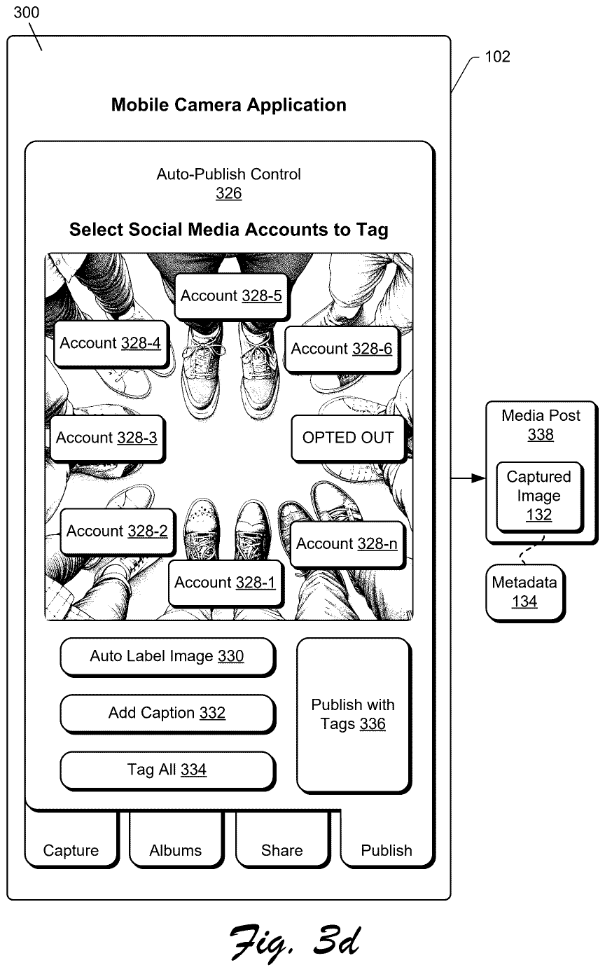

FIG. 3a through FIG. 3d each depict an example graphical user interface (GUI) in accordance with one or more implementations. Each depiction of the GUI is labeled as GUI 300. The GUI 300, for instance, can be implemented on the mobile device 102 associated with the user 108 and incorporates attributes of the environment 100 and the system 200 introduced above. The camera application 120 controls the GUI 300 to provide access to the automatic tagging functions implemented by the nearby auto-tagger 126, for example, including to be used in connection with accessing the remote service 104. When the camera application 120 is executed by a processor of the mobile device 102, the UI control 202 causes a touchscreen on the mobile device 102 to present the GUI 300 and receive user inputs as the user 108 interacts with the GUI 300.

FIG. 3a depicts aspects of the example GUI 300 in accordance with one or more implementations. The GUI 300 depicted in FIG. 3a presents a camera control 302, which includes a camera viewfinder 304, a capture button 306, and a selectable element 308. The user 108 provides user input 310 at the camera control 302, for example, to interact with the camera viewfinder 304 (e.g., to control a zoom function that changes a field of view size of the camera 118. When the user 108 is satisfied with the picture being framed by the camera viewfinder 304, the user input 310 is received to select the capture button 306, which triggers the UI control 202 to issue the capture command 130, and generate the captured image 132. Toggling the selectable element 308 enables and disables the nearby auto-tagger 126.

In one or more examples, outer image regions of the captured image 132 encompass additional non-visible positions in the environment 100 that are outside the camera field of view captured by the camera viewfinder 304. For example, the camera viewfinder 304 depicted in FIG. 3a frames each person in the environment 100 to zoom in on their lower legs and feet. Faces of the people depicted in the camera viewfinder 304 are unrecognizable. If each user is holding one of the second mobile devices 112, each of the second mobile devices 112 is outside the camera viewfinder 304, e.g., located in the margins or beyond borders of the captured image 132. Although the second mobile devices 112 are positioned beyond the camera field of view, the second mobile devices 112 are positioned near to the field of view boundaries and are therefore counted among devices present in the captured image 132.

FIG. 3b depicts aspects of the example GUI 300 in accordance with one or more implementations. The GUI 300 depicted in FIG. 3b presents a recent image album 312, which includes a thumbnail of the captured image 132 among thumbnails of other captured images. The captured image 132 is stored in the recent image album 312 with the metadata 134. As depicted in this examples, the metadata 134 is generated to include a plurality of (e.g., a quantity of n) user identifiers 314 based on the radio messages 114 to indicate presence of a plurality of users of the plurality of second mobile devices 112 at different image regions 316 encompassing corresponding radio based position estimates that mobile device. The captured image 132 may be output to the album service 110-1, which catalogs the captured image 132 based on the user identifiers 314 and the image regions 316.

FIG. 3c depicts aspects of the example GUI 300 in accordance with one or more implementations. The GUI 300 depicted in FIG. 3c presents an auto-share control 318 to enable user control of how the captured image 132 is shared based on the metadata 134. For users of the second mobile devices 112 who opt-in to the auto-tagging function, selectable labels 320 are presented overlaid on the captured image 132 at or near the corresponding image regions recorded by the metadata 134. The user 108 provides the user input 310 to select individual selectable labels 320 (which are illustrated as user ID 320-1 through user ID 320-n), or chooses a select all option 322. After providing additional user input to a send to selected button 324, the captured image 132 is automatically sent to user accounts (e.g., email, message, phone) related to the user identifiers 314. The share service 110-2, for instance, automatically sends the captured image 132 to corresponding accounts linked to each of the user identifiers 314 tagged by the metadata 134.

As depicted in FIG. 3c, at least one of the users of the second mobile devices 112 opted out, and a label associated with that user is not available for selection. For example, the metadata generator 218 is configured to determine whether the user identifier or the device identifier based on the message information 212 is associated with a user account that allows automatic tagging functions. The metadata generator 218 refrains from generating the metadata 134 to tag the captured image 132 with the user identifier of a user account that does not allow the automatic tagging functions, and generates the metadata 134 to tag the captured image 132 with the user identifier when the user account allows the automatic tagging functions.

FIG. 3d depicts aspects of the example GUI 300 in accordance with one or more implementations. The GUI 300 depicted in FIG. 3d presents an auto-publish control 326 to enable user control of how the captured image 132 is published based on the metadata 134. For users of the second mobile devices 112 who opt-in to the auto-tagging function, selectable labels 328 are rendered or overlaid on the captured image 132 at or near the corresponding image regions recorded by the metadata 134. The user 108 provides the user input 310 to select individual accounts associated with the selectable labels 328 (which are illustrated as selectable labels 328-1 through 328-n). The user 108 may select an auto label image 330 option to include the selectable labels 328 in the captured image 132, or choose an add caption option 332 to add the selectable labels 328 to a caption of the captured image 132. The user 108 may select a tag all 334 option to automatically tag each of the selectable labels 328, without tagging other devices users that may have opted out. After providing additional user input to a publish with tags button 336, the captured image 132 is automatically embedded in a media post 338 distributed by the publish service 110-3. The publish service 110-3, for instance, automatically publishes the captured image 132 to include labels or a caption describing each of the user identifiers 314 tagged by the metadata 134. In at least one example, the labels include text or other indication of the user identifiers 314 being overlaid at the image regions 316 in the media post 338 of the captured image 132. These are just some ways of protecting privacy through the tagging service. There are various other ways that user privacy can be protected and users are allowed to opt out of the tagging service. For example, the remote service 104 configures the publish service 110-3 to remove labels or captions stored in the metadata 134 attached to the user identifiers 314 of users who opt out. As another example, users who opt out adjust device settings of the second mobile devices 112 to prevent the user identifiers 314 or other information from being shared in the environment 100. When the device settings disable access to the tagging service, that second mobile device 112 may refrain from broadcasting radio messages, or may use a unique identifier that is not associated with or traceable back to that user or device.

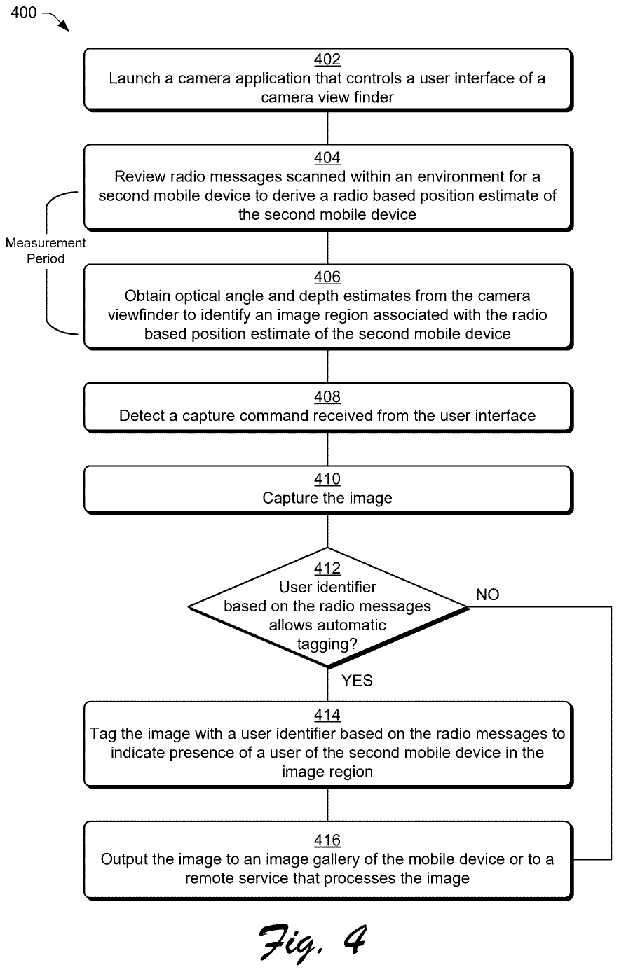

FIG. 4 illustrates a flow chart depicting an example method 400 for embedding nearby user presence within captured images in accordance with one or more implementations. Operations of the method 400, for instance, may be performed in the context of the environment 100, such as by the mobile device 102 and/or the system 200.

At operation 402, a camera application is launched that controls a user interface of a camera view finder. For example, the camera application 120 executes on a processor of the mobile device 102.

At operation 404, radio messages scanned within an environment for a second mobile device are reviewed to derive a radio based position estimate of the second mobile device. For example, the radios 116 infer position estimates based on the radio measurements 216 to be later projected onto image regions captured in a camera viewfinder.

Next, at operation 406, optical angle and depth estimates are obtained from the camera viewfinder to identify an image region associated with the radio based position estimate of the second mobile device. For example, the camera parameters 214, including a depth map, field of view size, etc., are used to correlate the radio based position estimates to pixel coordinates that are encompassed in the captured image 132.

In some examples, a measurement period begins at operation 404 and includes the operation 406. The measurement period repeats the operations 404 and 406 several times to obtain multiple radio based position estimates that are contemporaneous with the capture command 130.

At operation 408, a capture command received from the user interface is detected. For example, the UI control 202 issues the capture command 130 in response to user input detected at the capture button 306.

At operation 410, the image is captured. For example, the camera 118 generates the captured image 132.

Next, at operation 412, user identifiers based on the radio messages are checked to determine whether each allows automatic tagging. For example, the user identifiers associated with the second mobile devices 112 that have accounts with the automatic tagging service are included in the metadata 134 and those without accounts are omitted or a blank or default identifier to represent an anonymous person is used.

At operation 414, the image is tagged with a user identifier based on the radio messages to indicate presence of a user of the second mobile device in the image region. For example, the captured image 132 is tagged with the metadata 134.

At operation 416, the image is output to an image gallery of the mobile device or to a remote service that processes the image. For example, the captured image 132 is sent to the gallery application 122.

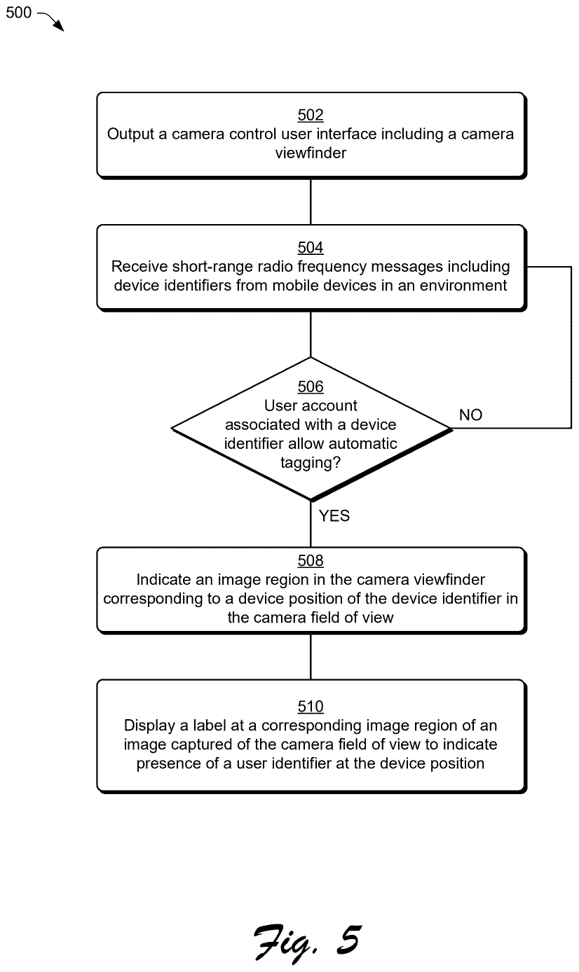

FIG. 5 illustrates a flow chart depicting an example method 500 for embedding nearby user presence within captured images in accordance with one or more implementations. Operations of the method 500, for instance, may be performed in the context of the environment 100, such as by the mobile device 102 and/or the system 200.

At operation 502, a camera control user interface is output including a camera viewfinder. For example, the GUI 300 is presented by the mobile device 102 to include the camera control 302 and the camera viewfinder 304.

At operation 504, short-range radio frequency messages are received including device identifiers from mobile devices in an environment. For example, the radios 116 configure the mobile device 102 to scan for the radio messages 114.

Next, at operation 506, whether a user account associated with a device identifier allows automatic tagging is determined. For example, the camera application 120 checks whether the radio based position estimates of the second mobile devices 112 being inferred from the radio messages 114 (e.g., and device identifiers contained therein) are associated with users of an automatic tagging service.

The method proceeds to operation 508 for each of the device identifiers that is determined at the operation 506 to be associated with a user of the automatic tagging service. At the operation 508, an image region is indicated in the camera viewfinder corresponding to a device position of the device identifier in the camera field of view. For example, the camera control 302 is updated by the camera application 120 to show the selectable labels 320 overlaid in the camera viewfinder 304 with updates occurring to compensate for movement of the mobile device 102 and the second mobile devices 112 before the user 108 triggers the capture command 130. The camera control 302 may receive user input as the user toggles the selectable labels 320 to include or not include that user identifier in the metadata 134 eventually generated and saved with the captured image 132 when the user 108 selects the capture button 306.

Lastly, at operation 510, a label is displayed at a corresponding image region of an image captured of the camera field of view to indicate presence of a user identifier at the device position. For example, the capture button 306 is selected to cause the camera application 120 to present the auto-share control 318 and display the selectable labels 320 within the GUI 300.

The example methods described above may be performed in various ways, such as for implementing different aspects of the systems and scenarios described herein. Any services, components, modules, methods, and/or operations described herein can be implemented using software, firmware, hardware (e.g., fixed logic circuitry), manual processing, or any combination thereof. Some operations of the example methods may be described in the context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 6 illustrates various components of an example device 600 in which aspects of embedding nearby user presence within captured images can be implemented in accordance with one or more implementations. The example device 600 can be implemented as any of the devices described with reference to the previous FIGS. 1-5, such as any type of mobile device, mobile phone, mobile device, wearable device, tablet, computing, communication, entertainment, gaming, media playback, and/or other type of electronic device. For example, aspects of the mobile device 102, the system 200, and/or the remote service 104 as shown and described with reference to FIGS. 1-5 may be implemented as the example device 600.

The device 600 includes communication transceivers 602 that enable wired and/or wireless communication of device data 604 with other devices. The radios 116 of the mobile device 102 are examples of the communication transceivers 602. The device data 604 can include any of device identifying data, device location data, wireless connectivity data, and wireless protocol data. Additionally, the device data 604 can include any type of audio, video, and/or image data. The device data 604 can include any type of communication data, such as radio measurements and radio messages. Example communication transceivers 602 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 600 may also include one or more data input ports 606 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processing system 608 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits 610. The device 600 may further include any type of a system bus or other data and command transfer system that couples the various components within the device. A system bus can include any one or combination of different bus structures and architectures, as well as control and data lines.

The device 600 also includes computer-readable storage memory 612 (e.g., memory devices) that enable data storage, such as data storage devices that can be accessed by a computing device, and that provide persistent storage of data and executable instructions (e.g., software applications, programs, functions, and the like). Examples of the computer-readable storage memory 612 include volatile memory and non-volatile memory, fixed and removable media devices, and any suitable memory device or electronic data storage that maintains data for computing device access. The computer-readable storage memory 612 can include various implementations of random access memory (RAM), read-only memory (ROM), flash memory, and other types of storage media in various memory device configurations. The device 600 may also include a mass storage media device. Computer-readable storage memory 612 represents media and/or devices that enable persistent and/or non-transitory storage of information in contrast to mere signal transmission, carrier waves, or signals per se. Computer-readable storage memory 612 do not include signals per se or transitory signals.

The computer-readable storage memory 612 provides data storage mechanisms to store the device data 604, other types of information and/or data, and various device applications 614 (e.g., software applications). The device applications 614 include the camera application 120 and the gallery application 122, for instance. As another example of device programs maintained in the computer-readable storage memory 612 include instructions for an operating system 616. The instructions can be maintained as software instructions within the memory 612 and executed by the processing system 608. The device applications 614 may also include a device manager, such as any form of a control application, software application, signal-processing and control module, code that is native to a particular device, a hardware abstraction layer for a particular device, and so on.

In this example, the example device 600 also includes a camera 618 and motion sensors 620, such as may be implemented in an inertial measurement unit (IMU). The motion sensors 620 can be implemented with various sensors, such as a gyroscope, an accelerometer, and/or other types of motion sensors to sense motion of the device. The various motion sensors 620 may also be implemented as components of an inertial measurement unit in the device. The camera 618 is an example of the camera 118, and is usable by the camera application 120 to capture images, including the captured image 132. The motion sensors 620 are used as input devices, for example, to detect when the user 108 is holding the device 600 with the camera 618 pointed away, including movement (e.g., during the measurement period) when the user 108 frames the camera viewfinder 304 to capture a scene.

The device 600 also includes a wireless module 622, which is representative of functionality to perform various wireless communication tasks. For example, the camera application 120 communicates the captured image 132 to the remote service 104 through a network connection established by the wireless module 622 to the network 106.

The device 600 can also include one or more power sources 624, such as when the device is implemented as a mobile device. The power sources 624 may include a charging and/or power system, and can be implemented as a flexible strip battery, a rechargeable battery, a charged super-capacitor, and/or any other type of active or passive power source.

The device 600 also includes an audio and/or video processing system 626 that generates audio data for an audio system 628 and/or generates display data for a display system 630. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 632. In implementations, the audio system and/or the display system are integrated components of the example device. Alternatively, the audio system and/or the display system are external, peripheral components to the example device.

Although implementations of embedding nearby user presence within captured images have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following:

In some aspects, the techniques described herein relate to a mobile device, including: a radio operable to scan for and exchange radio messages with a plurality of second mobile devices within an environment, a camera configured to frame the environment within a camera field of view, a memory configured to maintain an image gallery, and at least one processor configured to cause the mobile device to: review the radio messages for a second mobile device in the environment to derive a radio based position estimate of the second mobile device, obtain optical angle and depth estimates from a camera viewfinder to identify an image region associated with the radio based position estimate of the second mobile device, generate metadata of an image captured by the camera to tag the image with a user identifier based on the radio messages to indicate presence of a user of the second mobile device in the image region, and store the image including the metadata to the image gallery maintained in the memory.

In some aspects, the techniques described herein relate to a mobile device, wherein the at least one processor is configured to generate the metadata to tag the image with a plurality of user identifiers based on the radio messages to indicate presence of a plurality of users of the plurality of second mobile devices at different image regions encompassing a corresponding radio based position estimate for each of the plurality of second mobile devices.

In some aspects, the techniques described herein relate to a mobile device, wherein the at least one processor is configured to scan the radio messages for the second mobile device in response to launching a camera application that controls a user interface of the camera viewfinder.

In some aspects, the techniques described herein relate to a mobile device, wherein the at least one processor is configured to generate the metadata of the image in response to detecting a capture command received from the user interface.

In some aspects, the techniques described herein relate to a mobile device, wherein the at least one processor is configured to derive the radio based position estimate and obtain the optical angle and depth estimates based on the radio messages scanned during a measurement period occurring prior to detecting the capture command.

In some aspects, the techniques described herein relate to a mobile device, wherein the at least one processor is configured to derive the radio based position estimate as one of a plurality of radio based position estimates derived during the measurement period.

In some aspects, the techniques described herein relate to a mobile device, wherein the plurality of radio based position estimates include at least four radio based position estimates derived during the measurement period, and the at least one processor is configured to perform visual-inertial odometry based on the at least four radio based position estimates.

In some aspects, the techniques described herein relate to a mobile device, wherein the at least one processor is configured to derive the radio based position estimate during the measurement period using a patch antenna of the mobile device to derive angle of arrival directional estimates based on the radio messages.

In some aspects, the techniques described herein relate to a mobile device, wherein the radio includes a short-range radio frequency radio and the radio messages include short-range messages including a device identifier that includes the user identifier.

In some aspects, the techniques described herein relate to a mobile device, wherein the radio includes at least one of a Bluetooth radio, a Bluetooth Low Energy radio, or an Ultra-Wide Band frequency radio.

In some aspects, the techniques described herein relate to a mobile device, wherein the radio includes a wifi radio and the radio messages include wifi messages including the user identifier or a device identifier.

In some aspects, the techniques described herein relate to a system including: at least one processor configured to cause the system to: review radio messages scanned within an environment for a second mobile device in the environment, derive a radio based position estimate of the second mobile device based on the radio messages, obtain optical angle and depth estimates from a camera viewfinder to identify an image region associated with the radio based position estimate of the second mobile device, obtain a user identifier from the radio messages or based on a device identifier obtained from the radio messages, generate metadata of an image captured to tag the image with the user identifier to indicate presence of a user of the second mobile device in the image region, and output the image including the metadata to an image gallery maintained in a memory.

In some aspects, the techniques described herein relate to a system, wherein the at least one processor is configured to determine whether the user identifier or the device identifier is associated with a user account that allows automatic tagging functions, and refrain from generating the metadata to tag the image with the user identifier when the user account does not allow the automatic tagging functions.

In some aspects, the techniques described herein relate to a system, wherein the at least one processor is configured to determine whether the device identifier is associated with a user account that allows automatic tagging functions, and generate the metadata to tag the image with the user identifier when the user account allows automatic tagging functions.

In some aspects, the techniques described herein relate to a system, wherein outer image regions of the image encompass additional non-visible positions in the environment that are outside a camera field of view.

In some aspects, the techniques described herein relate to a system, wherein the at least one processor is further configured to send the image to the second mobile device.

In some aspects, the techniques described herein relate to a method, including: reviewing, by a mobile device, radio messages scanned within an environment for a second mobile device, deriving, by the mobile device, a radio based position estimate of the second mobile device based on the radio messages, obtaining, by the mobile device, optical angle and depth estimates from a camera viewfinder to identify an image region associated with the radio based position estimate of the second mobile device, determining, by the mobile device, a user identifier based on the radio messages, generating, by the mobile device, metadata of an image captured to tag the image with the user identifier to indicate presence of a user of the second mobile device in the image region, and outputting, by the mobile device, the image including the metadata to an image gallery maintained in a memory.

In some aspects, the techniques described herein relate to a method, further including: outputting, by the mobile device, the image to a photo album service that catalogs the image based on the user identifier tagged by the metadata.

In some aspects, the techniques described herein relate to a method, further including: outputting, by the mobile device, the image to a sharing service that automatically sends the image to an account linked to the user identifier tagged by the metadata.

In some aspects, the techniques described herein relate to a method, further including: outputting, by the mobile device, the image to a publishing service that automatically includes an indication of the user identifier overlaid at the image region in a media post of the image.

1. A mobile device, comprising:
a radio operable to scan for and exchange radio messages with a plurality of second mobile devices within an environment;
a camera configured to frame the environment within a camera field of view;
a memory configured to maintain an image gallery; and
at least one processor configured to cause the mobile device to:
review the radio messages for a second mobile device in the environment to derive a radio based position estimate of the second mobile device;
obtain optical angle and depth estimates from a camera viewfinder to identify an image region associated with the radio based position estimate of the second mobile device;
generate metadata of an image captured by the camera to tag the image with a user identifier based on the radio messages to indicate presence of a user of the second mobile device in the image region; and
store the image including the metadata to the image gallery maintained in the memory.

2. The mobile device of claim 1, wherein the at least one processor is configured to generate the metadata to tag the image with a plurality of user identifiers based on the radio messages to indicate presence of a plurality of users of the plurality of second mobile devices at different image regions encompassing a corresponding radio based position estimate for each of the plurality of second mobile devices.

3. The mobile device of claim 1, wherein the at least one processor is configured to scan the radio messages for the second mobile device in response to launching a camera application that controls a user interface of the camera viewfinder.

4. The mobile device of claim 3, wherein the at least one processor is configured to generate the metadata of the image in response to detecting a capture command received from the user interface.

5. The mobile device of claim 4, wherein the at least one processor is configured to derive the radio based position estimate and obtain the optical angle and depth estimates based on the radio messages scanned during a measurement period occurring prior to detecting the capture command.

6. The mobile device of claim 5, wherein the at least one processor is configured to derive the radio based position estimate as one of a plurality of radio based position estimates derived during the measurement period.

7. The mobile device of claim 6, wherein the plurality of radio based position estimates comprise at least four radio based position estimates derived during the measurement period, and the at least one processor is configured to perform visual-inertial odometry based on the at least four radio based position estimates.

8. The mobile device of claim 5, wherein the at least one processor is configured to derive the radio based position estimate during the measurement period using a patch antenna of the mobile device to derive angle of arrival directional estimates based on the radio messages.

9. The mobile device of claim 1, wherein the radio comprises a short-range radio frequency radio and the radio messages comprise short-range messages including a device identifier that includes the user identifier.

10. The mobile device of claim 9, wherein the radio comprises at least one of a Bluetooth radio, a Bluetooth Low Energy radio, or an Ultra-Wide Band frequency radio.

11. The mobile device of claim 1, wherein the radio comprises a wifi radio and the radio messages comprise wifi messages including the user identifier or a device identifier.

12. A system comprising:
at least one processor configured to cause the system to:
review radio messages scanned within an environment for a second mobile device in the environment;
derive a radio based position estimate of the second mobile device based on the radio messages;
obtain optical angle and depth estimates from a camera viewfinder to identify an image region associated with the radio based position estimate of the second mobile device;
obtain a user identifier from the radio messages or based on a device identifier obtained from the radio messages;
generate metadata of an image captured to tag the image with the user identifier to indicate presence of a user of the second mobile device in the image region; and
output the image including the metadata to an image gallery maintained in a memory.

13. The system of claim 12, wherein the at least one processor is configured to determine whether the user identifier or the device identifier is associated with a user account that allows automatic tagging functions, and refrain from generating the metadata to tag the image with the user identifier when the user account does not allow the automatic tagging functions.

14. The system of claim 12, wherein the at least one processor is configured to determine whether the device identifier is associated with a user account that allows automatic tagging functions, and generate the metadata to tag the image with the user identifier when the user account allows automatic tagging functions.

15. The system of claim 12, wherein outer image regions of the image encompass additional non-visible positions in the environment that are outside a camera field of view.

16. The system of claim 12, wherein the at least one processor is further configured to send the image to the second mobile device.

17. A method, comprising:
reviewing, by a mobile device, radio messages scanned within an environment for a second mobile device;
deriving, by the mobile device, a radio based position estimate of the second mobile device based on the radio messages;
obtaining, by the mobile device, optical angle and depth estimates from a camera viewfinder to identify an image region associated with the radio based position estimate of the second mobile device;
determining, by the mobile device, a user identifier based on the radio messages;
generating, by the mobile device, metadata of an image captured to tag the image with the user identifier to indicate presence of a user of the second mobile device in the image region; and
outputting, by the mobile device, the image including the metadata to an image gallery maintained in a memory.

18. The method of claim 17, further comprising:
outputting, by the mobile device, the image to a photo album service that catalogs the image based on the user identifier tagged by the metadata.

19. The method of claim 17, further comprising:
outputting, by the mobile device, the image to a sharing service that automatically sends the image to an account linked to the user identifier tagged by the metadata.

20. The method of claim 17, further comprising:
outputting, by the mobile device, the image to a publishing service that automatically includes an indication of the user identifier overlaid at the image region in a media post of the image.
